(19) United States
(12) Patent Application Publication
(10) Pub. No.: US 2023/0410218 A1
(43) Pub. Date: Dec. 21, 2023

(54) RECONCILIATION IN THE AUTOMATED DISTRIBUTION OF GRATUITIES

(71) Applicant: TipHaus, Inc., Port Orchard, WA (US)

(72) Inventors: Leif MAGNUSON, Seattle, WA (US); Macgregor GAINOR, Bellingham, WA (US); Taylor BIRKELAND, Seattle, WA (US)

(21) Appl. No.: 18/201,665

(22) Filed: May 24, 2023

Related U.S. Application Data
(63) Continuation-in-part of application No. 17/723,108, filed on Apr. 18, 2022.
(60) Provisional application No. 63/345,381, filed on May 24, 2022.

(51) Int. Cl. G06Q 40/12

(52) U.S. Cl. CPC G06Q 40/125

(57) ABSTRACT

This disclosure describes techniques for implementing a distribution policy to improve user experience (UX) and reconciliation of gratuities among employees in a business setting. The distribution policy may include one or more rules that can define an apportionment of gratuities among multiple employees such as, without limitation, upon a closing of a transaction at a time of sale. In one embodiment, the distribution policy may be associated with a user account of an employee. In this embodiment, the distribution policy may include conditions and parameters that relate to the apportionment of gratuities of the employee.

### CROSS-REFERENCE TO RELATED APPLICATIONS

This application is a continuation-in-part of U.S. application Ser. No. 17/723,108 filed on Apr. 18, 2022, entitled “Automated Distribution of Gratuities,” and claims the benefit of U.S. Provisional Application No. 63/345,381 filed on May 24, 2022, entitled “Improving User Experience (UX) for Automated Distribution of Gratuities”, which are herein incorporated by reference in their entirety.

### BACKGROUND

For certain service-based businesses, it is customary to give a gratuity, or tip, to one or more employees who perform a service. Although a customer may primarily interact with a subset of employees of the service-based business, such as a server and a host of a restaurant, many other employees may have contributed or assisted in varying degrees in supporting the service provided to the customer. In a restaurant, for example, a host may initially entertain and seat the customer to a table, a busser may set and clear the table, a food runner may deliver food, a bartender may prepare and/or serve alcoholic beverages, and a valet driver may bring the customer's car to the restaurant entrance. Other employees may similarly provide specific services for the benefit of the customer during their dining experience.

Continuing with this example, at the end of the meal, the customer may have the opportunity to give a tip directly to the server or add the gratuity to an amount paid for the meal. In the case of valet parking, the customer may additionally tip the valet. In some scenarios, one or both of these tips may then be shared among the employees who assisted in providing service to the customer, or aggregated and distributed among employees regardless of whether they provided direct assistance for a specific transaction (e.g., dishwashers or maintenance personnel) according to customs or practices of a given business or industry. The sharing of gratuities has often been manually calculated and documented, complicating business accounting, employee earnings, and the like. Further, a basis for sharing of gratuities has often been non-transparent, especially to employees that rely on the apportioning of these gratuities.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a schematic view of a network server environment that implements a distribution policy to improve the user experience (UX) with an automated distribution of gratuities among employees of subscriber-establishments.

FIG. 2 is a diagram of an example network server environment in which an accounting management server may implement a distribution policy and reconciliation process that can be used as a reference for the distribution of gratuities and pay reconciliation as described herein.

FIG. 3 is a diagram of an example of gratuity distribution over a particular gratuity distribution period, in accordance with at least one embodiment.

FIG. 4 is a diagram of an example of gratuity distribution over completed orders that span/range from an opening of the corresponding order/transaction to an entry of a time of sale for each of the orders/transactions.

FIG. 5 is a block diagram of an example look-up table (LUT) that that can be used for gratuity distribution by the accounting management server over the completed transaction such as upon the time of sale as described in FIG. 4.

FIG. 6 is an example subscriber user interface that shows accessing of the tip management application to manually configure various fields and conditions that may effect changes in gratuity percentages for a particular time window during a gratuity distribution period, in accordance with at least one embodiment.

FIGS. 7A-8B illustrate an example of a reconciliation process performed, e.g., by the reconciliation module according to at least one embodiment.

FIG. 9 is a flow diagram of an example methodological implementation of setting up a distribution policy to be carried out, for example, by a user entering data and rules in the accounting management server of FIG. 2.

FIG. 10 is a flow diagram of an example methodological implementation by the accounting management server of a distribution policy in determining how to apportion a gratuity at the end of a gratuity distribution period, in accordance with at least one embodiment.

FIG. 11 is a flow diagram of an example methodological implementation for availing by the employee of features of the tip management application, such as the tip management application.

FIG. 12 is a flow diagram of an example methodological implementation that may be performed by the accounting management server (specifically, the reconciliation module) to reconcile an employee's pay at the end of a pay period, in accordance with at least one embodiment.

### DETAILED DESCRIPTION

Every day during a pay period, the overall amount that an employee will take home is calculated based on one or more of the job the employee was working, the total time worked, and what tip rules are applied. This disclosure describes technological solutions for establishing, customizing, and implementing a tip apportionment and distribution policy (hereinafter, “distribution policy”) in an automated reconciliation of gratuities among tip earners and/or other employees in a business setting. The disclosure also relates to a user device, a point-of-sale (POS) device, and a network system, any or all of which may implement the technology in a variety of scenarios.

The technological solutions may include a platform to provide for the entry of employees and job codes, as well as apportionment rules, reconciliation rules, distribution rules, and the logic to enforce these rules, among other things. Included, or provided separately, may be instructions on how to use the platform to manage and reconcile tip apportionment and distribution. In some examples, the instructions guide an administrator, manager, or other user in the entry of various data and rules, including but not limited to employee information and job codes defined for the system rules, report generation, and others. In accordance with the rules and entered data, software, when executed by one or more processors, may carry out the apportionment and distribution of tips, perform reconciliations, generate reports, and perform other operations as described herein.

The disclosed platform allows the employer to see the amount of tips that each employee is eligible to take home, the percentage amount that is withheld pending reconciliation, the amount that is payable, the amount that is available for payout, and the actual amount that was paid out to an employee. Withholding in this way allows for the ability to hold a percentage of funds until the end of the pay period, in turn allowing for final reconciliation for any changes to an employee's earnings. For example, changes to an employee's earnings can be from a refund, shift change, clock adjustment, etc. At the end of a pay period, the subscriber can finalize its data, and the platform may reconcile the data, taking any negative adjustment amounts and applying them to the withheld amount. This provides the final amount the employee is able to receive. Examples of calculating payout and discrepancies during pre-payout and post-payout are described below.

The POS device, or POS, may be associated with a subscriber establishment and include components such as a tip management application and a database. A subscriber establishment, or subscriber, is an example of an entity that may subscribe to a platform described herein. Examples may include, without limitation, a restaurant, carwash service, online or offline delivery provider, babysitter service, golf caddy, disc jockey, and/or other similar subscribers that apportion pooled gratuities among their employees or workers for each gratuity distribution point, period, or cycle.

It should be noted that a subscription is but one way to implement the platform. The platform could be purchased or licensed by subscription or according to a different agreement. Aspects of the platform may be supported by personal or automated customer service. For consistency and clarity, in this description “subscriber” may refer to any such entity or agreement.

In general, the POS may be located at the subscriber premises. The POS may be used for a variety of things including, in some instances, the periodic or real-time inputting of data and sending the same to an account management server for further processing. The account management system may be on subscriber premises or reached via one or more networks. The input data may include, without limitation, sales entries; amounts of gratuities; timestamps for payment of gratuities, opening a transaction, the end of rendering customer service, or completing an order such as entering bill payment or closing of a tab; clocking in and out of a shift; and more. The POS may also be used to enter user information or confirm conditions of the distribution policy as described herein.

The account management server, which can host the subscription service, may receive input data from a subscriber, identify a tip distribution policy that corresponds to the input data, process the input data based upon the distribution policy, generate output data that can indicate how gratuities are to be distributed, and transmit the output data back to the subscriber (e.g., the POS) and/or other entities. In some instances, the account management server may distribute tips according to the distribution policy and/or other instructions as described elsewhere herein. The account management server may also store, integrate, and/or reconcile output data that can include apportioned gratuities of employees who may be working for different subscribers to the platform but isolated from other subscribers for privacy and security. That is, the employee may have access to their own records at various employer subscribers via a tip management app described elsewhere herein, but the subscribers do not have access to the systems of other subscribers. The account management server may also allow the employees to configure entities that can access or receive their apportioned gratuities, send feedback to the account management server, and/or to request changes on their user accounts. For example, some or all of the gratuities may be forwarded to one or more entities such as a bank or other financial institution, tax agency, bankruptcy court, collecting agency, credit card companies. Accordingly, the UX and employee/subscriber accounting may be improved when using the automated distribution and/or reconciliation of gratuities as described herein.

As described herein, “tips” may refer to gratuities, gifts, presents, donations, rewards, handouts, or other compensation that can be pooled, reconciled, and distributed to the employees in addition to any corresponding base wages. Many examples herein describe the familiar restaurant or bar scenario where it is customary to add a tip to the check or cost of the meal, drink, or service performed. Typically in these scenarios, the tip is calculated roughly as a percentage of the check, although tips received for valet parking, cab hailing, delivery (including third party (“gig”) delivery), and like services that are not directly tied to a purchase price may also be managed as described.

Many of the techniques described herein can be used to establish and enforce a distribution policy by which the distribution of tips, and the amount of tips to be distributed (in figures or percentages), may be determined based on a variety of factors, including but not limited to one or more of job role, worker experience, length of shift (assigned or actual), time of shift, party size, participation over a particular service or order, position or change in position during the rendering of the service or order, user profile, performance, length of overlapping shifts between employees, day of the week (including whether weekend or holiday), or other conditions. The distribution policy may allow a user, such as the store manager or administrator in charge of setting policy and rules to carry out the policy, to preconfigure the percentage sharing of a particular employee based upon these factors. The apportionment and distribution of gratuities may be implemented via execution of one or more algorithms to achieve the percentage sharing. In one or more examples, the algorithms, operating on the input data, may determine the total gratuity earned and/or output data representing the same for a particular employee over a particular gratuity distribution period, which may include summing the total amount of gratuities earned by all employees during the gratuity distribution period, dividing the total amount of gratuities by the total number of minutes clocked in by all employees, and attributing a portion of the total amount of gratuities to the particular employee based upon the particular employee's percentage sharing per unit time of work within the particular time period.

Tips may be distributed according to policies designed around tip sharing or tip pools. In tip sharing, tips may be distributed among tip earners of various job titles or roles based on percentages. For example, a tip rule might be established to distribute 10% of tips received by servers from the servers to the cooks, bussers, or other workers whose roles (e.g., preparing food or clearing tables) assist the tip-earning servers but are not ordinarily tipped separately. Tip pools offer a way for tip earners to split tips evenly rather than by percentage. For example, a tip pool can include both cooks and servers. In some examples, tip pools may be set up in conjunction with tip sharing to give the option of stacking a tip-sharing rule on the backside of a tip pool. For example, this could be done for two bartenders pooling their tips and sharing 3% of their food sales with the kitchen.

A gratuity period may be any period established over which tips are calculation for distribution. In many of these embodiments, after a full day of work (which may be the gratuity period or contain multiple gratuity periods), the platform will calculate which employees receive tip money and how much. Once done, there will be an amount that is assigned to each employee. This amount may be considered “banked” and can then be sent to others. Such embodiments may be configured so that employees will only be able to send money that is “in the bank”.

Other logic can be chosen at setup or edited after setup. For example, employees may be able to share a set percentage of their daily tips. Considering an employee who has made $100 by 3 pm and a threshold is set at 25%, the employee may be able to send $25 to a teammate or other recipient.

The distribution policy may include one or more rules that can define an apportionment of gratuities such as, without limitation, upon the closing of a transaction at a time of sale or the end of an employee's shift. The time of sale may include a completion of the transaction that can be associated with a payment of gratuities that may be distributed among the employees. The distribution policy may also define an authority of a user such as a store manager to configure a basis of apportionment, an ability of another user such as an employee to view his or her apportioned gratuities in real time, and/or other permissions that relate to accessing, reconciliation, and distribution of the gratuities.

The UX may include a subscriber interaction with an application such as a tip management application that can implement the automating of the gratuity distribution. In one embodiment, an accounting management server may monitor subscriber information such as, without limitation, an entry of a user code, opening of a tab, or other information that can be used as a reference to identify an associated distribution policy in the accounting management server. With the monitored user information, the accounting management server may implement the distribution policy and transmit or display one or more conditions, configurations, or rules to implement the distribution policy for confirmation by the user, and monitor activities of the user such as, without limitation, closing the transaction by entering the amount of gratuity at the POS, opening of a new tab to another customer, and the like. The accounting management server may use the monitored user activities and the associated distribution policy to reconcile the gratuities from the completed transactions at the end of the transaction.

Different distribution policies may be preconfigured and/or associated with different users, which may include employees with different status and/or nature of employment. For example, in the case of a tip earner, the distribution policy may include conditions that can trigger the time of work of the tip earner, rules regarding starting and/or ending of a gratuity distribution period, activities that change percentage sharing, and the like.

The gratuity distribution period can also be set according to an aperiodic factor based on, for example, the time of sale defined by a start/opening of an order or transaction (such as a bartender entering a liquor tab identifier for a customer, and/or a host registering a particular dining table for the customer) to closing or entry of the time of sale (e.g., input at the POS) for the rendered service or completed order; the time a delivery person leaves with an order until the order is delivered; or some other aperiodic factor. The gratuity distribution period may be different from an employee's pay period or payment of wage, which can cover multiple gratuity distribution periods.

The algorithm may include one or more sub-algorithms. For example, one sub-algorithm may be triggered by a condition such as a clocking-in of an employee, change in work assignment of the employee, or other condition that changes the employee's previous percentage share. In these examples, the gratuity distribution period can be periodic or aperiodic such as when the cycle is based upon an opening and closing of the order/transaction. The closing of the order may include the entry of the time of sale data where the gratuity is entered as input data for further processing to generate the output data, which can be stored in an accounting database accessible by the accounting management server, and the stored output data can be accessed by the subscriber or others authorized by the subscriber.

Throughout this disclosure, “apportionment” and “distribution” may be used interchangeably as there is some overlap, but in general, “apportionment” refers to the amount or percentage of tips that go to different individuals and “distribution” refers to the delivery to personnel of the tips so apportioned.

Some implementations and operations described herein are ascribed to the use of a server; however, alternative implementations may execute certain operations in conjunction with or wholly within a different element or component of the system(s). Further, the techniques described herein may be implemented in a number of contexts, and several example implementations and context are provided with reference to the following figures. In addition, the term “techniques,” as used herein, may refer to system(s), method(s), computer-readable instruction(s), module(s)m algorithms, hardware logic, and/or operation(s) as permitted by the context described above and throughout the document.

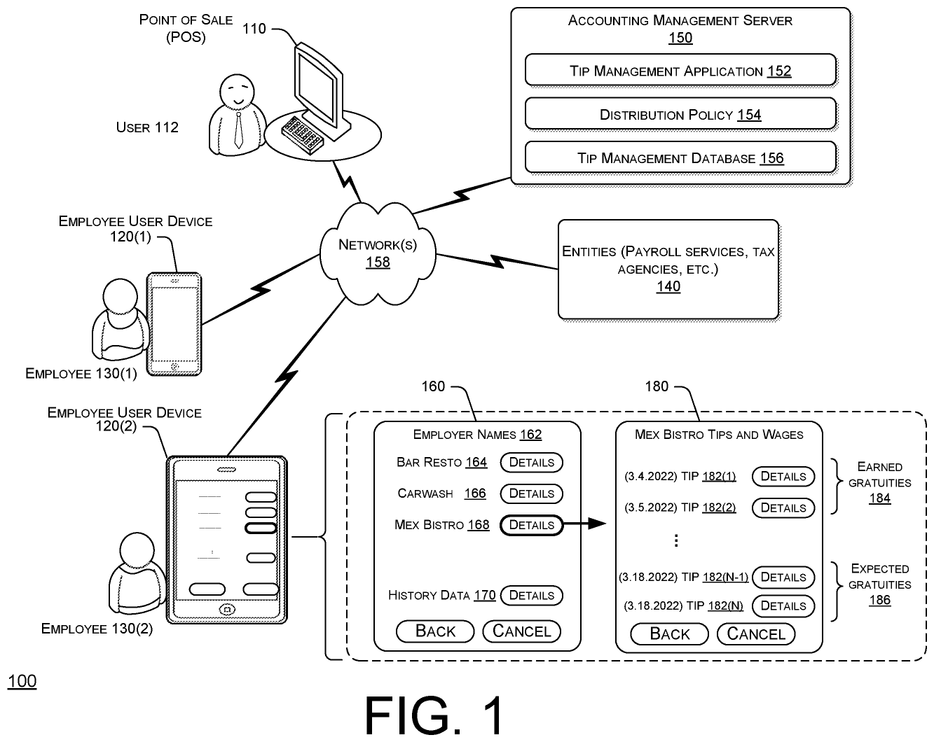

FIG. 1 illustrates a schematic view of a network server environment 100 that implements a distribution policy to improve the user experience (UX) with an automated distribution of gratuities among employees of subscriber-establishments. As shown, the network environment 100 may include a point-of-sale device (POS) 110 of a particular subscriber, a user 112 such as an administrator or a store manager, employee user devices 120(1), 120(2) that are associated respectively with employees 130(1), 130(2), one or more entities 140, and an accounting management server 150, one or more of which may communicate with each other over one or more networks 158, which may be or include a cellular network.

The POS 110 may be a computing device configured to receive data entered by the user 112 and receive data output by the accounting management server 150. The POS 110 may also serve as a terminal at which an employee 120 may clock in for work, sales transactions may be performed, or tip management activities may be recorded or observed, although some of these functions may be performed elsewhere. Administration of part or all of the software platform described herein, including but not limited to setting up or editing rules, may also be performed at the POS 110 in some embodiments.

In one embodiment, the user 112 may be an administrator or store manager who can configure, via the POS 110 and by accessing the accounting management server 150, the apportioning of gratuities over a gratuity distribution period, which can include a periodic cycle, an aperiodic distribution, or a combination thereof. For example, the periodic cycle may be every hour, end of day, end of week, or some other fixed time period. The aperiodic distribution can be after the rendering of a particular service or completion of a customer order at the time of sale, random or unscheduled clocking in and out by an employee, an event occurring during an employee's shift, or other aperiodic or arbitrary condition that can be associated with a gratuity.

Referencing the user device 120(2), and at a first instant 160, the employee 130(2) may view on the user device's user interface their gratuity records from one or more subscriber employers. In the illustrated example, one or more of the employee's employer names 162 such as a bar restaurant 164, carwash 166, and Mexican bistro 168 are shown, and the employee 120(2) selects the Mexican bistro 168 via a button link to history data 170 displayed at the first instant 160. At a second instant 180, and upon clicking/opening further details of the Mexican bistro 168 by clicking an adjacent “Details” button, the employee 130(2) can also view their earnings, including earned gratuities 184 and expected gratuities 186 (which include tips 182(1)-182(N)) from different dates and/or gratuity distribution periods. The earned gratuities 184 may be stored as data on the accounting management server 150 or locally that can be further received and processed by the one or more entities 140, such as a bank that can facilitate direct deposit of the employee's wages and/or gratuity earnings.

For example, the user device 120(2) that is associated with the employee 130(2) may be authorized to access the stored data to verify updates on the employee's previous, current, and expected gratuity income (if any). As shown at the first instant 160, the employee 130(2) can view at a user interface a different employer, if the employee holds more than one job whose employer also subscribes to the service that provides the automated distribution of gratuities. The employee 130(2) may then view additional details of each employment as shown at the second instant 180. Here, the employee can view the earned gratuities 184 and the expected gratuities 186 for the Mexican bistro in the illustrated example. In one embodiment, and every pay period, a particular entity such as an employee's bank may process the data from the accounting management server 150 to facilitate the direct deposit of the employee's earned gratuities 184 to the employee's bank account. In another embodiment, another entity such as a collecting agency may process the data from the accounting management server 150 to garnish the employee's earned gratuities 184 for child support, and so on.

As shown, the number of blocks, information, employees, and associated user devices are for illustration purposes only, and additional POSs, employees, and user devices can be included within the scope of the embodiments described herein.

The accounting management server 150 may further include a tip management application 152, a distribution policy 154, and a tip management database 156. In one or more embodiments, the accounting management server 150 may receive input data from a subscriber POS 110, identify the distribution policy 154 that corresponds to the input data, process the input data based upon the distribution policy 154, and generate output data that indicates how gratuities are to be distributed. In the network environment 100 of FIG. 1, the accounting management server 150 may transmit the output data back to the subscriber POS 110 and/or other entities. In at least one embodiment, the accounting management server 150 may be local to the subscriber, for example as a component of the POS, and thus “transmitting the output data” is not necessarily over a network. The accounting management server 150 may store, integrate, and/or reconcile output data that can include apportioned gratuities of employees who may be working for different subscribers. The accounting management server 150 may also allow the employees to configure entities using a tip management app on their own user device that can view their earned tips, access those tips, and/or to request changes on their user accounts, among other features.

In some embodiments, the tip management application 152 may represent software that, when executed by one or more processors, can carry out operations from entering data to calculating tips to distributing the tips. Configuring the tip management application 152 may include entry of various employee and job-related data. For example, each employee may have an employee profile, each job or role may be given a job code, and each job code may be associated with a percentage of tips to be distributed. The configuration may also call for the entry of rules to carry out the distribution policy, including the apportionment and distribution of funds. The authorization to enter data or new rules, or change any of them, may be associated with permissions. For example, an employee may have authority to access their own employee profile and, e.g., make changes to contact information, request days off, send messages to the system administrator, etc. A manager may have authority to access employee profiles, grant or deny leave requests, change job codes, and set employee schedules. An administrator may have all of the permissions of the manager plus the authority to edit and create rules, including but not limited to setting or changing apportionment percentages.

Typically the installed software solution will be ready for configuring. Among the data that may be entered, by way of example and not limitation, are administrator, manager, tip earner, and other employee names, contact information, and other personnel information typically maintained by an employer; access permissions for each person and/or job; one or more job codes associated with each job; payroll period; gratuity earning and distribution periods; and various operational and performance metrics (including metrics for evaluating distribution policies and generating reports). The setup may be wizard-driven.

In some embodiments, the POS 110 and/or the user devices 120(1), 120(2) may include an electronic communication device, including but not limited to, a smartphone, a session initiation protocol (SIP) phone, a laptop, a personal computer, a personal digital assistant (PDA), a satellite radio, a global positioning system (GPS), a multimedia device, a video device, a camera, a game console, a tablet, a smart device, a wearable device, or any other similar functioning device. In one embodiment, the POS 110, and/or the user devices 120(1), 120(2) may communicate with the accounting management server 150 to avail of automated distribution and/or reconciliation of gratuities as described in different embodiments herein.

A network server such as the accounting management server 150 may utilize distributed computing resources (e.g., one or more computing devices) that can operate in a cluster or other configuration to share resources, balance load, increase performance, provide fail-over support or redundancy, or for other purposes. The accounting management server 150 may include one or more interfaces to enable communications with the POS 110, user devices 120, and other networked devices via the one or more network(s) 158. The one or more network(s) 158 may include public networks such as the Internet, private networks such as an institutional and/or personal intranet, or some combination of private and public networks. The one or more network(s) 158 can also include any type of wired and/or wireless network, including but not limited to local area network (LANs), wide area networks (WANs), satellite networks, cable networks, Wi-Fi networks, Wi-Max networks, mobile communications networks (e.g., 3G, 4G, and so forth), or any combination thereof.

The distribution policy 154 may include one or more rules that can define apportionment of gratuities such as, without limitation, at the time of sale, authorization of users to configure basis of apportionment, conditions for the users to send feedback, confirmation, or request changes, and other conditions that relate to guidelines of implementing gratuity distributions. Different distribution policies may be associated with different users or employees with different status and/or nature of employment. For example, in the case of the user 112, the distribution policy 154 may include authorizations to configure reconciliation methods for the distribution of the gratuities to the employees 130(1) and 130(2), allow and/or select user codes that can avail of the gratuities or change job positions, and/or change other configurations that relate to the gratuity distribution. Reconciliation can be set to occur at any time, for example once per day after closing, after a particular time of day, multiple times per day such as after each scheduled shift, or at the end of any other established gratuity period. Reconciliation can also be set for “on demand” by an employee so that an employee can obtain up-to-the-minute numbers in real time. On-demand reconciliation may also refer to the user 112 being able to update subscriber records between regularly scheduled reconciliations. Reconciliation may also be set to occur at the end of a pay period without taking advantage of the ability to monitor distribution progress. In another example, in the case of the employee 130(1) or 130(2), the distribution policy 154 may include conditions that can trigger the time of work of the employee, rules regarding starting and/or ending of a gratuity distribution period, activities that change percentage sharing of the employee, parameters that can be changed by the employee such as the entity that can access the employee's account, and the like. In these examples, the accounting management server 150 may request from the user a confirmation of the conditions, rules, or guidelines in the distribution policy 154 before the running of the tip management application.

The one or more entities 140 may include another server or servers that can be operated by financial institutions, payroll agencies, tax agencies, bankruptcy court, credit card companies, collection agencies, payday loan lenders, creditors, or other institution that can process output data from the accounting management server 150. In one embodiment, the one or more entities 140 may adopt the distribution policy 154 to control access by the subscribers to their corresponding output data or other subscriber information/data for further processing. The subscriber information/data may include the name of the subscriber, its (or its user) status and limit of authorization, etc.

In an example operation, the accounting management server 150 may be configured to monitor user information such as, without limitation, user 112 or subscriber geolocation, entry of a user code for the user 112, or other information that can be used to identify the associated distribution policy 154. With the monitored user information, the accounting management server 150 may identify the associated distribution policy 154 that can be used to define the conditions or rules that can apply to the apportioning of the gratuities. In one instance, the accounting management server 150 may transmit one or more conditions, configurations, or rules for confirmation by the user. For example, the user 112 may approve that the gratuity distribution period to be applied is upon the time of sale. In another example, the user 112 may approve that the apportioned gratuity for the day will be transmitted to a particular bank, etc.

With the selected and/or confirmed one or more conditions, conditions, and/or rules, the accounting management server 150 may then monitor activities such as, without limitation, opening of the tab, change in position or assignment, closing the transaction by entering amount of gratuity to the POS, and the like. In this instance, the accounting management server 150 may use the monitored user activities and the conditions, rules, or guidelines in the associated distribution policy 154 to apportion the corresponding gratuity for the employee(s).

In one example, the accounting management server 150 may be configured to execute one or more algorithms or sub-algorithms (as conditions in the distribution policy) to determine how to distribute gratuities over one or more gratuity distribution periods and for one or more different users. In this example operation, the sub-algorithms may be executed based upon occurrence of conditions and/or presence of other parameters that relate to the distribution of gratuities at the end of the gratuity distribution period. These conditions and/or parameters may be defined in the distribution policy 154.

For example, employees 130(1) and 130(2) may have the same percentage sharing (or rate), position, assigned gratuity distribution period, etc. and worked for 2 hours (6:00 AM to 8:00 AM) in a particular working day. Assuming that the gratuity distribution period is 2 hours and employee 130(2) is assigned by the store manager to work at a different position at the second hour (7:00 AM to 8:00 AM), which corresponds to a different percentage apportionment of the total gratuity, then the gratuity distribution period of two hours may be subdivided into different time windows with different corresponding sub-algorithms to calculate respective portions of the total gratuity for each employee. The time windows, for example, may include a first time window between 6:00 AM to 7:00 AM where both employees have the same percentage apportionment of the gratuities, and a second time window between 7:00 AM to 8:00 AM where the change in position of the employee 130(2) triggers the use of another sub-algorithm due to the change in relative percentages. The triggering of the sub-algorithm may be implemented, for example, upon detection of the change in assignment, which can be entered by the user 112, or by the employees themselves in some instances. In a case where the assignments of the employees were preconfigured, the triggering may be based upon the current time during the employees' working shifts. Further, in a case where the gratuity distribution period for both employees in the above example is based upon a beginning or a completion of an order where the order was opened at 6:00 AM and closed at 8:00 AM (time of sale), similar calculations can be performed to calculate the apportioning of the gratuities for both employees.

In at least one embodiment, the tip management application 152 may generate the gratuity earnings of the employees at the end of each gratuity distribution period. The gratuity earnings may be collated and summed at the end of the employees' individual pay periods. In addition, or in the alternative, the gratuity earnings of an individual employee may be summed, e.g., at the end of a work shift or even per transaction such as upon time of sale to complete an order or rendering of a service. The calculated gratuity earnings may be stored in the account database 156 where the stored data can be accessed by the user devices 120, the subscriber POS 110, one or more entities 140, and/or other network devices. In some cases, an authorization from the user 112 or subscriber may be needed for the other network devices to access the subscriber's or employee's data.

In at least one embodiment, the accounting management server 150 may include hardware, software, or a combination thereof, to receive input data from the subscriber, process the input data, and generate output data that can be transmitted in real-time to the subscriber and/or another entity or entities such as a bank, tax agencies, etc. The tip management application 152 may implement the distribution policy that corresponds to the user 112 that avails of the automated distribution of the gratuities in an employment environment.

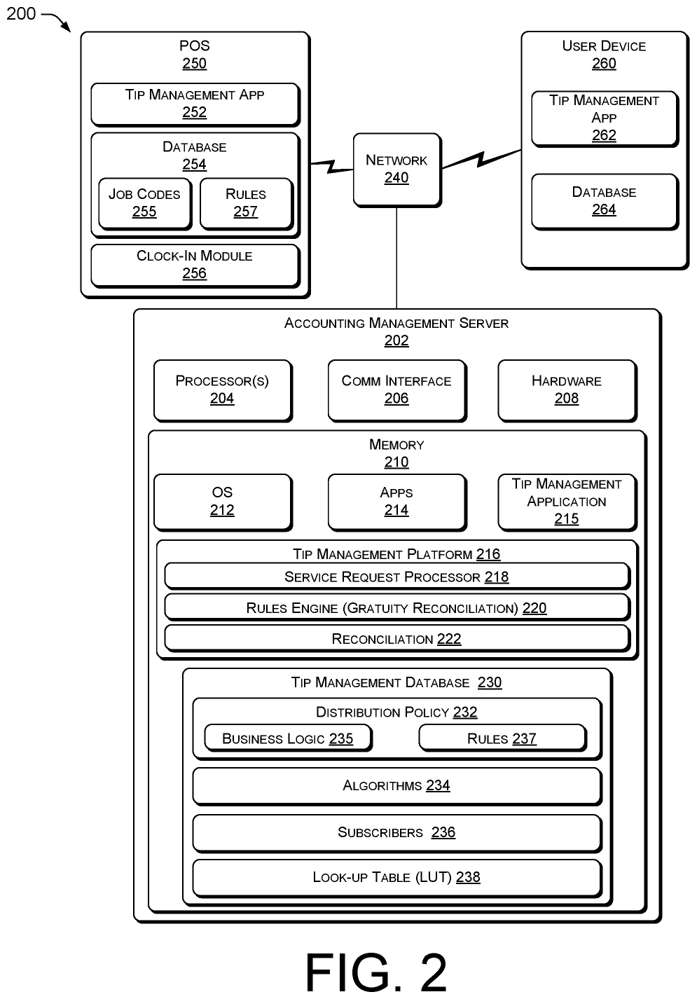

FIG. 2 is a diagram of an example network server environment 200 in which an accounting management server 202 may implement a distribution policy 232 that can be used as a reference for the distribution of gratuities as described herein. The accounting management server 202 may correspond to the accounting management server 150 of FIG. 1. The accounting management server 202 may be communicatively connected, via one or more networks 240, to a POS 250 and a user device 260. The POS 250 and the user device 260 may correspond to the POS 110 and the user device 120, respectively, of FIG. 1.

The accounting management server 202 may include one or more processors 204 having electronic circuitry that executes instruction code segments by performing basic arithmetic, logical, control, memory, and input/output (I/O) operations specified by the instruction code. The processors 204 can be a product that is commercially available through companies such as Intel® or AMD®, or customized to work with and control a particular system. The accounting management server 202 may also include a communications interface 206 and miscellaneous hardware 208.

The communication interface 206 may communicate with components located outside the accounting management server 202 and provide networking capabilities for the accounting management server 202. For example, the accounting management server 202, by way of the communications interface 206, may communicate with subscribers and/or one or more entities that can be authorized by the subscribers to use the subscriber data. The subscriber data may include distributed gratuities, pending gratuity distributions that can include portions of gratuities for the gratuity distribution period, and associated subscriber information such as, without limitation, job codes, positions, hours of work, etc. Communications between the accounting management server 202 and the user device 260 or POS 250 may utilize any suitable communication protocol for sending and receiving data and/or voice communications.

The miscellaneous hardware 208 may include hardware components and associated software and/or firmware used to carry out device operations. Included in the miscellaneous hardware 208 may be one or more user interface hardware components not shown individually—such as a keyboard, a mouse, a display, a microphone, a camera, and/or the like—that support user interaction with the accounting management server 202.

The accounting management server 202 may also include memory 210 that stores data, executable instructions, modules, components, data structures, etc. The memory 210 may be implemented using computer-readable media. Computer-readable media includes, at least, two types of computer-readable media, namely computer-readable storage media and communications media. Computer-readable storage media includes, but is not limited to, Random Access Memory (RAM), Dynamic Random Access Memory (DRAM), Read-Only Memory (ROM), Electrically Erasable Programmable Read-Only Memory (EEPROM), flash memory or other memory technology, Compact Disc-Read-Only Memory (CD-ROM), digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. As defined herein, computer-readable storage media do not consist of and are not formed exclusively by, modulated data signals, such as a carrier wave. In contrast, communication media may embody computer-readable instructions, data structures, program modules, or other data in a modulated data signal, such as a carrier wave, or other transmission mechanisms.

An operating system 212 may be stored in the memory 210 of the accounting management server 202. The operating system 212 can control a functionality of the processor(s) 204, the communications interface 206, the miscellaneous hardware 208, and couples the processor(s) 204 with the memory 210. Furthermore, the operating system 212 may include components that enable the accounting management server 202 to receive and/or transmit data via various inputs (e.g., user controls, network interfaces, and/or memory devices), as well as process data using the processor(s) 204 to generate output. The operating system 212 can include a presentation component that controls presentation of output (e.g., display the data on an electronic display, store the data in memory, transmit the data to another electronic device, etc.). Additionally, the operating system 212 can include other components that perform various additional functions generally associated with a typical operating system. The memory 210 that is in communication with the processor(s) 204 also stores various software applications 214, or programs, that provide or support functionality for the accounting management server 202, or provide a general or specialized device user function that may or may not be related to the example computing device per se.

The one or more processors 204 and the memory 210 may implement a tip management platform 216 that may incorporate a tip management application 215 that corresponds at least in part to the tip management application 152 of FIG. 1, including such software as routines, program instructions, objects, and/or data structures that are executed by the processors 204 to perform particular tasks or implement particular abstract data types. The one or more processors 204 in conjunction with the tip management platform 216 may further operate and utilize a service request processor 218, a rules engine 220, a reconciliation module 222, and a tip management database 230 including a distribution policy 232, algorithms and/or sub-algorithms 234, subscribers 236, and a look-up table (LUT) 238.

The tip management application 215, when executed as part of the tip management platform 216, may manage the automated distribution and/or reconciliation of gratuities among subscriber employees over one or more gratuity distribution periods. The tip management platform 216 may implement, for example, the distribution policy 232 to process input data and to generate output data that includes the apportionment of gratuities. One or more algorithms and/or sub-algorithms 234 may be run on the tip management platform 216 to generate the output data that can include gratuity earnings for each of the employees. Software of the tip management platform 216 may be a single block of executable instructions or it may be made up of several components. The components included in at least one implementation are described elsewhere herein. However, it is noted that in some implementations, more or fewer components may be configured and that one or more operations attributed to a particular component in the following description may be implemented in one or more other components.

The accounting management server 202 may allow the user 112 to enter the employee's personal information, assign job code/job position (role), and/or set or edit rules 237 to determine apportionment and/or distribution for the job position or type of service. This data may be linked as described elsewhere herein such that, when new information or changes to information are entered in a database field, data in another field may change accordingly (e.g., a change in job position may trigger an increase in gratuity percentage). Based on the associated distribution policy 232, other parameters may be configured that can be used as variables by the algorithms and/or sub-algorithms 234 to generate the output data over a particular gratuity distribution period.

In one example, the generation of the output data over the particular gratuity distribution period may include running a plurality of sub-algorithms due to occurrence of conditions such as, without limitation, working hours that overlap gratuity periods, clocking in within a certain window by another employee having a different role to assist in a transaction, change in assignment of the employee, and similar conditions that trigger changes in percentage sharing of the employees. In this example, the occurrence of the condition may trigger execution of another sub-algorithm for purposes of calculating the gratuity earned by each of the employees at the end of the gratuity distribution period.

The service request processor 218 may process one or more service requests that can be received from the POS 250 or user devices that are associated with the subscriber's employees. One functionality of the service request processor 218 may be to verify the source of the service request. For example, the service request processor 218 may parse the parameters of the received service request and use the parsed parameters, such as an identification of the user device 260, to verify whether the device identification is associated with a particular subscription. In this example, the subscriber may authorize during an initial sign up or during a period of subscription to the tip management platform 216 the user device or devices, POSs, and/or entities that can access subscriber data or employee data. Access to the subscriber data or employee data may be performed via use of a username, email address, job code, and/or the like.

The rules engine 220 may be configured to run one or more algorithms to reconcile the pooled gratuities over one or more gratuity distribution periods for each of the subscriber establishments. A subscriber may utilize different algorithm(s) from another subscriber. In one embodiment, the rules engine 220 may run multiple sub-algorithms to calculate portions of gratuities for different time windows within a particular gratuity distribution period. In this embodiment, the different sub-algorithms may be triggered by changes in percentage sharing of the subscriber employees.

The reconciliation module 222 may implement a reconciliation process to adjust an employee's pay to correct for inconsistencies between amount paid out in a previous pay period and amount earned.

The distribution policy 232 may define the conditions, rules, and/or configurations for the distribution of the gratuities of the users such as manager employees, staff employees, and the like. Different algorithms, calculations, conditions, and/or rules of the distribution policy may be associated with different users depending upon the nature of employment of the users and other information that relate to conditions of the percentage sharing by the users. The distribution policy 232 may correspond to the distribution policy 154 as described above in FIG. 1.

In one example, the POS 250 may be associated with the subscriber establishment and include components such as a tip management application 252, a database 254, and a clock-in module 256. In this example, the POS 250 may be used to periodically or in real-time send input data to the accounting management server 202 for further processing. The input data may include, without limitation, sales entries, amounts of gratuities, timestamp for payment of gratuities, timestamp for opening a transaction such as entering a tab number for a customer or designating a dining table for the customer, timestamp for ending of rendering service to customers or completing an order such as entering bill payment or closing of the tab number, clocking in and out by employees, changes in gratuity distribution period, assigned percentage sharing for certain position, adjustments in percentage sharing of the employee, and other data that relate to the distribution of gratuities over one or more gratuity distribution periods. In one instance, the POS 250 may also be used to enter user information or confirm conditions of the distribution policy as described herein.

Job codes 255 may be stored in the database 254 and are generally associated with shifts and not individual transactions, although modifications may be made, e.g., by overriding manually a sale to match a job code 255 with the sale so that an employee who is not clocked in but worked on the sale, or a manager who is not associated with a job code, can receive credit for the sale. Job codes 255 are also associated with employees based upon their roles. Employees may log in for a shift via the clock-in module 256 at the POS 250, their user device 260, or another terminal. An employee who has clocked in may be associated with a job code 255 for that shift, corresponding to the employee's role, and/or for some other reason. An employee who is not clocked in (for example, has forgotten to clock in, helps before clocking in, or continues to work after clocking out) may not be associated with a job code 255 for those efforts and thus not included when tips are distributed per the distribution policy, in which case the employee and the appropriate job code must be entered manually for them to ensure that they receive a portion of the tip. Managers are not generally tipped employees and may not clock into shifts; if they assist with a tipped transaction, a job code 255 may be associated with them for that shift so that they receive a portion of the tip for that transaction.

In some instances, it may become desirable to create “ghost” or “generic” job codes among the job codes 255 for various reasons. A “ghost” or “generic” job code is one that is not utilized by a single employee per se, but rather a group of employees or a method to introduce external sales into the POS. Examples may include third-party delivery services, online orders (including those performed entirely by the customer via a website), events/banquets, or shared sales registers/terminals, where no single employee clocks in or clocks out of that specific job code. In some embodiments, the ghost job code may be incorporated in the rules 237, pools, etc., weighted to zero for apportionment purposes. This way, the tip money being collected from online orders and the like can be apportioned discretionarily and distributed to employees who are clocked in at that time. In other embodiments, a ghost job code can be used to distribute tips collected from online orders to the employees who helped fill that order, such as a host, expo, cook, etc.

An example: All sales are rung up under a single ghost bartender employee for multiple bartenders working at any given time, which is sometimes done to use the same terminals without clocking in or out. The sales generated by the ghost bartender employee can be auto-assigned to a “ghost bartender” job code. A tip pool can be created that includes all or some of the actual bartenders (using the bartender job code) and the ghost bartender job code, too. In this example, the ghost bartender job code may be set to a weight of 0 so that the tips allocated to it are added to a true job code or distributed differently. Similarly, using a ghost job code, or a fake job code assigned to online and/or delivery orders, tips included in the credit card payment may be distributed entirely (or according to any weight or percentage) to supporting staff. In another example, a fake code can be assigned to the subscriber-establishment, for example “house”, if a portion of gratuities is to be retained that way.

The rules 237 to carry out the distribution policy may be set and edited by the user 112, depending on permissions. Without limitation, rules 237 may enforce percentages of distribution based on various factors such as role or job code, experience, day of the week, time of day, gratuity period (generally, the shift or portion thereof for clocked-in employees), time of sale, and others as devised by, e.g., the administrator. For example, a server may be associated with a job code 255 that is entitled to 50% of tips over the job shift or other gratuity period, whereas a busser may receive 25%, based on the busser's job code. Non-tipped earners who share in the tip distribution, such as cooks, may have a job code 255 that ensures 10% of the tips according to the distribution policy, leaving 15% to be distributed to others (or retained by the restaurant) in this example.

Other rules 237 to be set may include the distribution frequency and weighting. A rule's distribution frequency specifies how often tip distribution will occur. For example, a “daily” distribution may distribute tips based on total minutes worked throughout the day. An “hourly” distribution may work in a similar way, based on hours instead of minutes. A “time of sale” distribution may distribute tips from each sale based on minutes worked between sale open and close. In some embodiments, this may mean that employees who were working from the time the check was opened in the POS 250 until the check was paid would participate in the distribution. Other distributions may take into account sales numbers; if all employees work four-hour shifts, but the evening staff has double the sales, distribution frequencies based on hours or time of day may more fairly compensate employees who worked the busier shifts.

An example: Suppose a rule that says that servers give up 10% of tips to food runners. If the server makes $100 in tips, then $10 will be distributed among the food runners, leaving $90 for the server.

Sales-based rules work a bit differently. Take the example above and assume that the $100 tip was for a single order, and further assume that the order consisted of $50 worth of sales. Even though the tip is the same, the 10% rule apportions $5 to the food runners in this instance, leaving $95 for the server.

Weighting rules enable the tip management platform 216 to set up a single rule that apportions tips according to a ratio, for example 4:1 for bartender and barback. In this example, no matter how many barbacks or bartenders are clocked in, the bartenders, as a group, will receive four times as many tips as the barbacks as a group. Accordingly, if no one is clocked in as bartender, then the barbacks will get all the tips. In another example, where the bar's tips come from the server's tips, if no one is clocked in to either bartender or barback, the server will retain the tips if the shift requires the server to cover the bar (or the bar is closed).

The user device 260 may be an employee's electronic device that can be used to access the employee's gratuity earnings from one or more employers and/or one or more gratuity distribution periods. In one example, the user device 260 may utilize the tip management application 262 to access the accounting management server 202. The user device 260 may also include a database 264 to store data related to the employee's expected wages, available wages, and/or other information that is related to the employee's employment and/or gratuity earnings.

In one embodiment, the user device 260 may be configured to send user information to the accounting management server 202. For example, the information may include the employee's arrival for work, signifying the start of a shift or “time of work”. In another example, the information may include entry of a job code 255, and the like. In this embodiment, the user device 260 may receive one or more conditions of the distribution policy 232 that is associated with the user information. The user device 260 may then be used to confirm the one or more conditions of the distribution policy; transmit one or more activities of the employee; and receive reconciliation of pooled gratuities at the time of sale.

The algorithms 234 may include preconfigured algorithms and/or sub-algorithms, associated variables, and other information that can be used for corresponding algorithms and/or sub-algorithms. In one embodiment, the conditions that trigger the running of a sub-algorithm may be preconfigured via an initial input from the user 112. The conditions may include clocking in by another employee during rendition of a service or completion of an order, changing of working assignment, or similar scenario that changes percentage sharing of the employee within a gratuity distribution period. In this embodiment, the conditions and other parameters may be included in the distribution policy 232.

The subscriber database 236 may store the information associated with the subscriber establishments, such as name of the establishment, nature of establishment, employee information, gratuity distribution periods observed by the subscribers for their employees, authorized subscriber personnel who can configure percentage sharing of the employees, different sources of gratuities within the subscriber establishment, and the like. In one example, the employee information may include personal information, the device identification associated with the employee, employee position, and the like.

The LUT 238 may store preconfigured variables associated with the algorithm(s) for distributing the gratuities in the subscriber establishments as described herein. In one embodiment, a particular percentage sharing of a particular employee is associated with a particular one or more conditions that can be represented by different variables. In this embodiment, the LUT 238 may include the particular percentage sharing of the employee for the particular one or more conditions. When a monitored condition occurs, a new time window is generated and the LUT 238 can be used to identify the corresponding sub-algorithm to be used over the new time window within the gratuity distribution period.

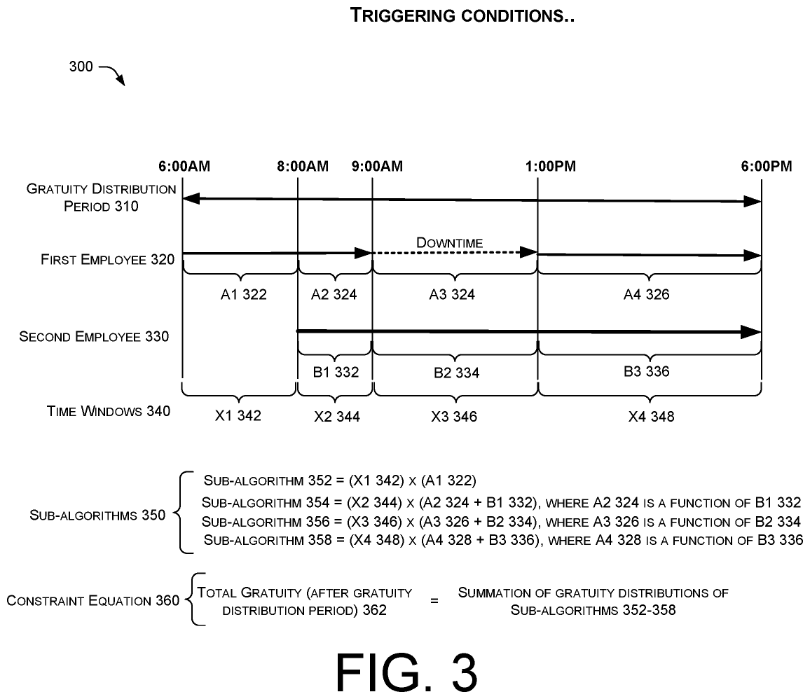

FIG. 3 is a diagram of an example of gratuity distribution 300 over a particular gratuity distribution period, in accordance with at least one embodiment. Features and conditions as described in FIG. 3 may be defined in the distribution policy as described herein. FIG. 3 shows a gratuity distribution period 310 (e.g., 6:00 AM-6:00 PM), a first employee 320, second employee 330, a time window 340, sub-algorithms 350, and a constraint equation 360. The first employee 320 and the second employee 330 may correspond to employees 130(1) and 130(2) of FIG. 1, respectively.

FIG. 3 shows time windows 340, which include time window X1 342, time window X2 344, time window X3 346, and time window X4 348 that can represent different time windows within the gratuity distribution period 310. The time windows can include unit values of minutes, hours, days, or other time period that is equal to or less than the gratuity distribution period. For the first employee 320, variables A1 322, A2 324, A3 326, and A4 324 may represent the first employee's corresponding percentage sharing over different time windows X1 342, X2 344, X3 346, and X4 348, respectively. For the second employee 330, variables B1 332, B2 334, and B3 336 may represent the second employee's corresponding percentage sharing over the time windows X2 344, X3 346, and X4 348, respectively. For a particular time window, the percentage sharing of the first employee 320 may be a function of or at least related to the percentage sharing of second employee 330. For example, the percentage sharing of the first employee 320 may be 80% while the percentage sharing of the second employee 330 is 20% for the time window X2 344. In this example, the percentage sharing of the first employee 320 may be a function of the percentage sharing of the second employee 330 since the total percentage sharing totals 100% of a portion of the pooled gratuity to be distributed at the time window X2 344. In some embodiments, different arbitrary conditions other than overlapping shifts may be associated with the percentage sharing of the first employee 320 and the second employee 330. For example, a change in assignment or an occurrence of an open bar may double the effort or work to be performed by the first employee 320. In this example, the change in assignment or occurrence of the open bar may be reflected in a condition that can be associated with a larger percentage apportioned to the first employee 320. The change in assignment or the occurrence of the open bar, and the corresponding change in apportionment, may be implemented via manual entries by the corresponding employee or in some cases, can be preconfigured to occur at a certain hour within the gratuity distribution period 310 if the change is expected.

The different associated conditions may trigger different time windows due to changes in an employee's percentage sharing that correspond to different sub-algorithms or calculations. For illustration purposes, the first employee 320 and the second employee 330 may have the same gratuity distribution period of 12 hours (6:00 AM to 6:00 PM). Further, the total amount of gratuities at the end of the gratuity distribution period 310 may include a summation of gratuities earned by the first employee 320 and the second employee 330 over the different time windows as demonstrated by a constraint equation 360.

The gratuity distribution period 310 may include a cycle for apportioning gratuities to the employees. The cycle may include a periodic or aperiodic time period that can be preconfigured for each employee and can be different between days of the week, holidays, presence of events, and the like. In one embodiment, the gratuity distribution period 310 for each employee may be adjusted based on days of the week, holidays, employee's assignment, work hours, time of sale, section in the subscriber establishment such as valet section, bar, dining section, and the like. In this embodiment, the adjusted gratuity distribution period 310 may still include one or more time windows depending upon the occurrence of conditions that trigger changes in percentage sharing of the employees that claim a share in the total gratuity over that particular time window.

Each of the time windows X1 342, X2 344, X3 346, and X4 348 may represent a time period within the gratuity distribution period 310, where changes in percentage sharing for the reconciliation of the gratuities may require a different form of calculation or sub-algorithm. For example, sub-algorithms 352-358 may be executed for the time windows X1 342, X2 344, X3 346, and X4 348, respectively. In this example, each of the sub-algorithms may be triggered by an occurrence of a condition that changes the percentage sharing of at least one of the employees over a particular gratuity distribution period. Here, the variables A1 322, A2 324, A3 326, and A4 324 may respectively include preconfigured percentage apportionment to the first employee 320 based upon the occurrence of the corresponding conditions. Similarly, the variables B1 332, B2 334, and B3 336 may include preconfigured percentage apportionment to the second employee 330 based upon the occurrence of the corresponding conditions. These conditions and corresponding percentages may be stored in the LUT 238.

Referencing FIG. 3, a particular working shift of the first employee 320 may include working between 6:00 AM-6:00 PM with a four hour downtime (e.g., time away from tipped work) between 9:00 AM-1:00 PM. Similarly, the working shift of the second employee 330 may include working between 8:00 AM-6:00 PM. In this scenario, a change in condition may occur at 8:00 AM that triggers the time window X2 344 when the second employee 330 clocks in and the working shift of the second employee overlaps with the working shift of the first employee. Similarly, another change in condition occurs and triggers the time window X3 346 when the first employee leaves the tipped shift while the second employee remains. Another change in condition may trigger the time window X4 348 when the first employee comes back from downtime, and their working shifts overlap again between 1:00 PM-6:00 PM. Each of the occurring conditions in this example may correspond to changes in the respective percentages of the employees and thus, the use of different sub-algorithms. In one embodiment, the changes in conditions may be monitored and detected based upon a timestamp of the clocking in and out of the employees in the subscriber-establishment, current time clock or time of day, or a combination thereof. In this embodiment, each of conditions may be associated with a job code of the employee, job title, job assignment, or other parameter that can identify and associate the employee to the changes in conditions.

Upon identification of the different time windows within the gratuity distribution period 310, the accounting management server may run the sub-algorithms 352-358 to determine distribution of the gratuities for the corresponding time windows. For example, sub-algorithm 352 may be based upon multiplication of X1 342 and A1 322. In this example, X1 342 may include a time period while A1 322 corresponds to the percentage sharing of the first employee 320 over the X1 322 time window. In another example, sub-algorithm 354 may be based upon multiplication between X2 344 and A2 324, and between X2 344 and B1 332. In this other example, the sub-algorithm 354 may treat the variable A2 324 as a function of the variable B1 332. By using the constraint equation 360, the two unknown variables may be determined. The A2 324 and B1 332 may represent the percentage sharing of first employee 320 and second employee 330 over the X2 344 time window.

In another example still, the sub-algorithm 356 may be based upon multiplication between X3 346 and A3 326, and between X3 346 and B2 334. Here, the sub-algorithm 356 may also treat the variable A3 326 as a function of the variable B2 334. The A3 326 and B2 334 may represent the percentage sharing of the first employee 320 and the second employee 330 over the X2 344 time window, and so on.

Upon determination of the percentages over each of the time windows, the accounting management server 202 may calculate the gratuities at each time window to generate the output data for each employee.

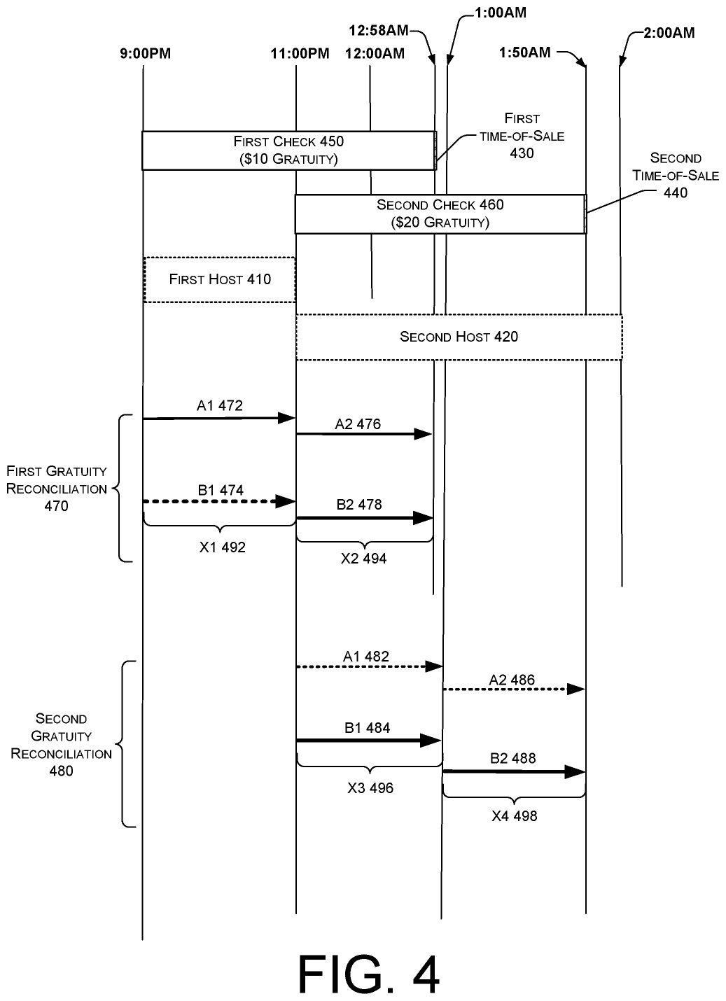

FIG. 4 is a diagram of an example of gratuity distribution over completed orders that span/range from an opening of the corresponding order/transaction to an entry of a time of sale for each of the orders/transactions. The entry of the time of sale may indicate the completion of the corresponding transaction such as when actual payment is made for the service rendered or completion of a customer's order (e.g., payment of a bar tab bill). FIG. 4 illustrates a reconciliation of total gratuity upon the entry of the time of sale, which can define an end of the corresponding aperiodic gratuity distribution period for the rendered service or completed order. Conditions associated with the use of the time of sale may be accessed from the distribution policy. As shown, a first host 410 and a second host 420 may represent employees while a first time of sale 430 and a second time of sale 440 can represent entries of a first check 450 and a second check 460, respectively. The first check 450, for example, may include payment of a bar tab that was opened by a first customer at 9:00 PM and closed at 12:58 AM while the second check 460 can include another payment for a separate bar tab that was opened by a second customer at 11:00 PM and closed at 1:50 AM. The opening of the bar tab may include an entry of a bar number that can be assigned or associated with a particular customer while the closing of the bar tab may include an entry of payment or other information that can indicate a completion of transaction. FIG. 4 further shows a first gratuity reconciliation 470 and a second gratuity reconciliation 480 that can represent apportioning of the gratuities at the time of the first time of sale 430 and the second time of sale 440, respectively.

Referencing the first gratuity reconciliation 470, A1 472 and B1 474 may represent the respective percentages of the first host 410 and the second host 420 at a first time window X1 492. Further, A2 476 and B2 478 may represent the respective percentages of the first host 410 and the second host 420 at a second time window X2 494.

Referencing the second gratuity reconciliation 480, A1 482 and B1 484 may represent the respective percentages of the first host 410 and the second host 420 at a third time window X3 496. Further, A2 486 and B2 488 may represent the respective percentages of first host 410 and the second host 420 at a fourth time window X4 498.

In one embodiment, the first time of sale 430 may define an end of an aperiodic gratuity distribution period and can be associated with a completion of a transaction that is paid according to the first check 450. For example, the transaction was opened at 9:00 PM and closed at 12:58 AM upon an entry of transaction payment, which is represented by the first time of sale 430. In this example, the gratuity ($10) may be immediately apportioned to the first host 410 and the second host 420 upon completion of the transaction. The reconciliation of the gratuity ($10) at the first time of sale 430 may utilize the sub-algorithms 234 for different time windows as described in FIG. 3 above.

For example, referencing the first gratuity reconciliation 470, the first time window X1 492 and the second time window 494 may correspond to different percentages for the first host 410 and the second host 420 over different time periods within the aperiodic gratuity distribution period of 3 hours and 58 minutes (i.e., 9:00 PM to 12:58 AM). At the first time window X1 492, note that even though there is no overlapping between working shift/hours by the second host 420 (11:00 PM to 2:00 AM) with the first host 410 (9:00 PM to 11:00 PM), one or more arbitrary conditions other the overlapping of working hours may be associated with the percentage—B1 474 of second host 420. For example, the second host 420 is preconfigured to receive 10% of a portion of the gratuity during the first time window X1 492 on account of the second host's position even though the second host did not work between 9:00 PM to 11:00 PM.

Referencing the second time window X2 494 of the first gratuity reconciliation 470, the second time window X2 494 may be triggered by changes in the respective percentages of the first host 410 and the second host 420 upon an occurrence of a condition such as the clocking in by the second host 420 at 11:00 PM. Here, a different sub-algorithm 234 may be utilized to calculate the respective percentages of the first host 410 and the second host 420 of the portion of the gratuity at the second time window X2 494. In some instances, the percentages of the first host 410 and the second host 420 at the first time of sale 430 may be linearly based upon number of minutes they served or provided for the completion of the transaction. In these instances, the first host 410 and the second host 420 may divide the $10 gratuity based upon their number of work hours such as 2 hours (9:00 PM to 11:00 PM) for the first host 410 and 1 hour 58 minutes (11:00 PM to 12:58 AM) for the second host 420.

In one embodiment, the amount of gratuity ($10) to be distributed for the first time of sale 430 may be equated with each sub-algorithm 234 to calculate the apportioned gratuities for the first host 410 and the second host 420. Since the percentage apportioned to the first host 410 is a function of the percentage apportioned to the second host 420, then the percentage to be apportioned to each host may be calculated.

Referencing the second gratuity reconciliation 480, the second time of sale 440 may define an end of another aperiodic gratuity distribution period and can be associated with a completion of a transaction that is associated with the second check 460. For example, the transaction was opened at 11:00 PM and closed at 1:50 AM upon an entry of a transaction payment, which is represented by the second time of sale 440. In this example, the gratuity ($20) may be immediately apportioned to the first host 410 and the second host 420 upon completion of the transaction. The reconciliation of the gratuity ($20) at the second time of sale 440 may similarly utilize the use of sub-algorithms 234 for different time windows as described in FIG. 3 above.

For example, referencing the second gratuity reconciliation 480, the third time window X3 496 and the fourth time window 498 may correspond to different respective percentages apportioned to the first host 410 and the second host 420 over different time periods within the aperiodic gratuity distribution period of 2 hours and 50 minutes (11:00 PM to 1:50 AM). At the third time window X3 496, note that even though there is no overlapping between working hours of the second host 420 (11:00 PM to 2:00 AM) with the first host 410 (9:00 PM to 11:00 PM), one or more arbitrary conditions other the overlapping of working hours may be associated with the percentage sharing A1 482 of the first host 410. For example, the first host 410 is preconfigured to have a percentage of A1 482 for the third time window X3 496 on account of first host's position even though the first host did not work between 11:00 PM to 1:00 AM. At the fourth time window X4 498, the first host 410 may be preconfigured to have a different percentage—A2 486 on account, for example, of first host's reward as employee of the year even though the first host did not work between 1:00 AM to 1:50 AM. In these examples, the one or more arbitrary preconfigured conditions that can be associated with each host can be programmed by the user 112. Further, the preconfigured one or more conditions can be preconfigured at different cycles, such as implementing aperiodic gratuity distribution periods for first half of the month and observing periodic gratuity distribution periods at the second half.

Similar to the first gratuity reconciliation 470, the amount of gratuity ($20) to be pooled at the second time of sale 440 may be applied to each sub-algorithm 234 to calculate the apportioned gratuities for the first host 410 and the second host 420. Since the percentage apportioned to the first host 410 is a function of the percentage apportioned to the second host 420, then the percentage apportioned to each host may be calculated.

The embodiment as described above is for simplicity of illustration and other arbitrary conditions may be associated that can trigger the use of different sub-algorithms 234. For example, and during an overlapping of shifts (not shown) between the first employee 320 and the second employee 330, multiple orders for the same opened transaction may be alternately entered by the first employee 320 or the second employee 330. This may happen, for example, in a bar where multiple bartenders may serve the same tab number. In this example, the percentage sharing during this overlapping period may be based upon number of orders entered, amount of order entered, and/or other arbitrary conditions that can be configured and associated with a particular percentage apportioned to the first employee 320 and the second employee 330 during this overlapping period. In this example still, a similar process for the distribution of the gratuity as described above can be implemented.

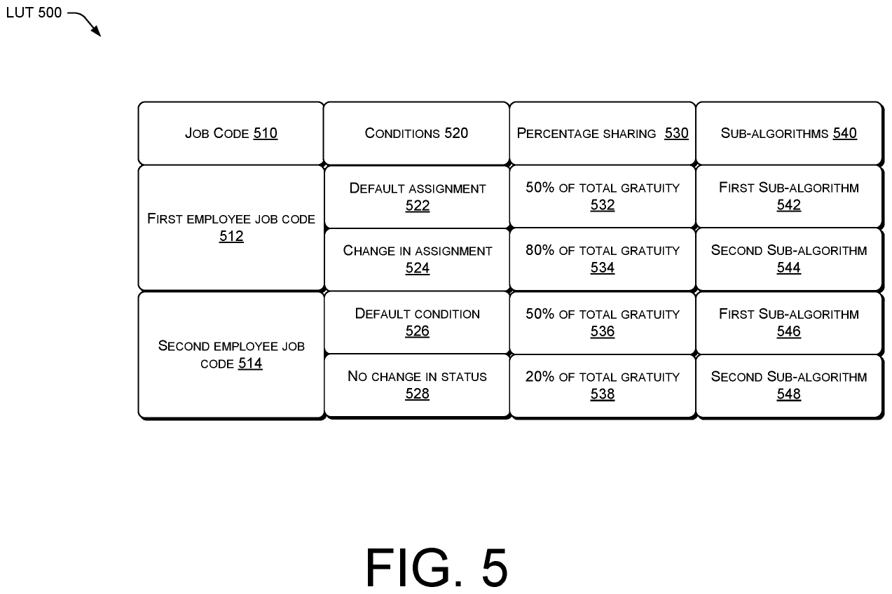

FIG. 5 is a block diagram of an example look-up table (LUT) 500 that that can be used for gratuity distribution by the accounting management server over the completed transaction such as upon the time of sale as described in FIG. 4 above. The example LUT 500 may correspond to the LUT 238 and can be an example implemented in a particular distribution policy to identify the sub-algorithms associated with percentage attribution and other information that are associated with job codes. The job codes may represent a particular position and/or employee identification for purposes of determining the distribution of the gratuity that can be attributed to the employee at the end of each gratuity distribution period.

As shown, the LUT 500 may include job codes 510, conditions 520, a corresponding percentage sharing 530, and associated sub-algorithms 540. The job codes 510 can be representative of any employee position such as manager, bartender, busser, chef, valet driver, and the like. For illustration purposes, only two job codes 510 are shown, including a first employee job code 512 and a second employee job code 514.

The conditions 520 may include preconfigured criteria that can be associated with the percentage sharing of the corresponding job code. For example, the conditions 520 may include an initial default assignment 522 and a change in assignment 524 for the first employee job code 512. Here, a detected change in assignment 524 from the initial default assignment 522 may trigger a change from a first sub-algorithm 542 corresponding to the default assignment 522 to use of a new sub-algorithm such as the second sub-algorithm 544. In this example, the first sub-algorithm 542 may be used in the previous default condition 542 where the first employee job code 512 and the second employee job code 514 are configured to share equally the amount of gratuities to be reconciled. However, upon detection of the change in assignment of the first employee job code 512, the second sub-algorithm 544 may be used to reflect changes in the corresponding percentage share 530 between the first employee job code 512 and the second employee job code 514.

In the example shown in FIG. 5, the change in assignment 524 may cause the second sub-algorithm 544 to change the division of gratuities between the first employee and the second employee from an entry 532 of 50% of the total gratuity associated with the first employee job code 512 and an entry 536 of 50% of the total gratuity associated with the second employee job code 514 to an entry 534 of 80% of the total gratuity associated with the first employee job code 512 and an entry 538 of 20% of the total gratuity associated with the second employee job code 514. In this example, there is no change in the status of the corresponding condition (assignment) associated with the second employee job code 514, as shown at 528. However, in another example, a change in an assignment or other condition associated with the second employee and second employee job code may trigger a change in the percentage sharing by, e.g., causing a change from a first sub-algorithm 546 associated with the default condition 526 to a second sub-algorithm 548 associated with the change in condition.

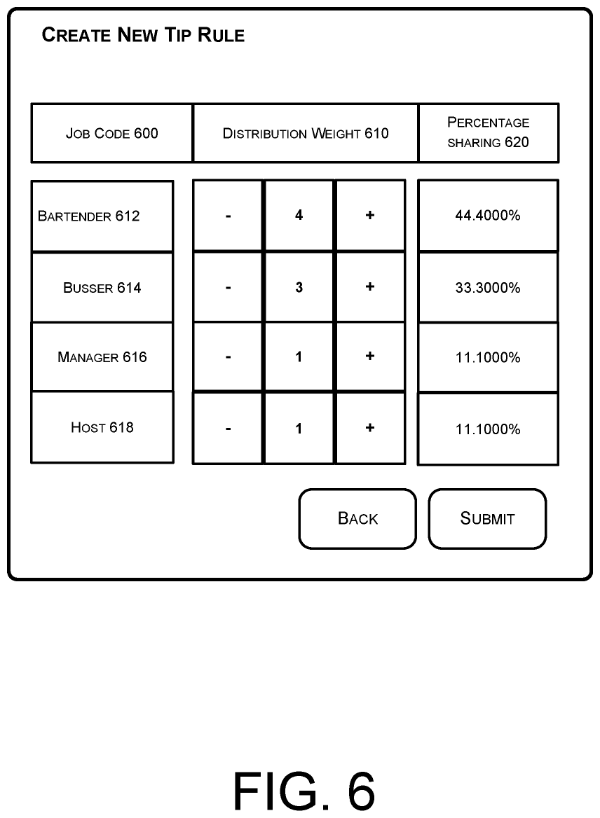

FIG. 6 is an example subscriber user interface that shows accessing of the tip management application to manually configure various fields and conditions that may effect changes in gratuity percentages for a particular time window during a gratuity distribution period, in accordance with at least one embodiment. As shown, the subscriber user interface may include fields for entry of parameters, e.g., by a subscriber/user, to enforce a distribution policy. In the illustrated example, those fields may include entries for a job code 600, a distribution weight 610, and percentage sharing 620 for the job code 600. The job code 600 and the percentage sharing 620 may correspond to the job code 510 and percentage sharing 530, respectively, of FIG. 5.

In the example shown in FIG. 6, which is not limited to the fields or values shown, job codes 600 may include code 612 for a bartender, code 614 for a busser, code 616 for a manager, and code 618 for a host. In one embodiment, the percentage sharing 620 may be used as a variable in corresponding sub-algorithms as described above. As illustrated, the subscriber (e.g., manager, supervisor, data entry clerk, or the like) may enter values for the distribution weight 610 or percentage sharing 620 for each job code 600 via the POS user interface to adjust on the fly the amount of gratuities associated with each job code. In some embodiments, additional conditions may be associated with each of the job code 600 that can change their percentage sharing similar to the triggering of conditions as described in FIGS. 3-4 above. Such conditions would have corresponding fields on the user interface so that the subscriber may alter the distribution amounts by making changes in those conditions in a similar manner.

In one example, adjustments of the distribution weights and other parameters that are tied to distribution amounts may be forwarded to the accounting management server, and the accounting management server may adjust the LUT information that can be associated with the employee job codes. In this example, the accounting management server may perform automated distribution of gratuities on behalf of the subscriber as described herein.

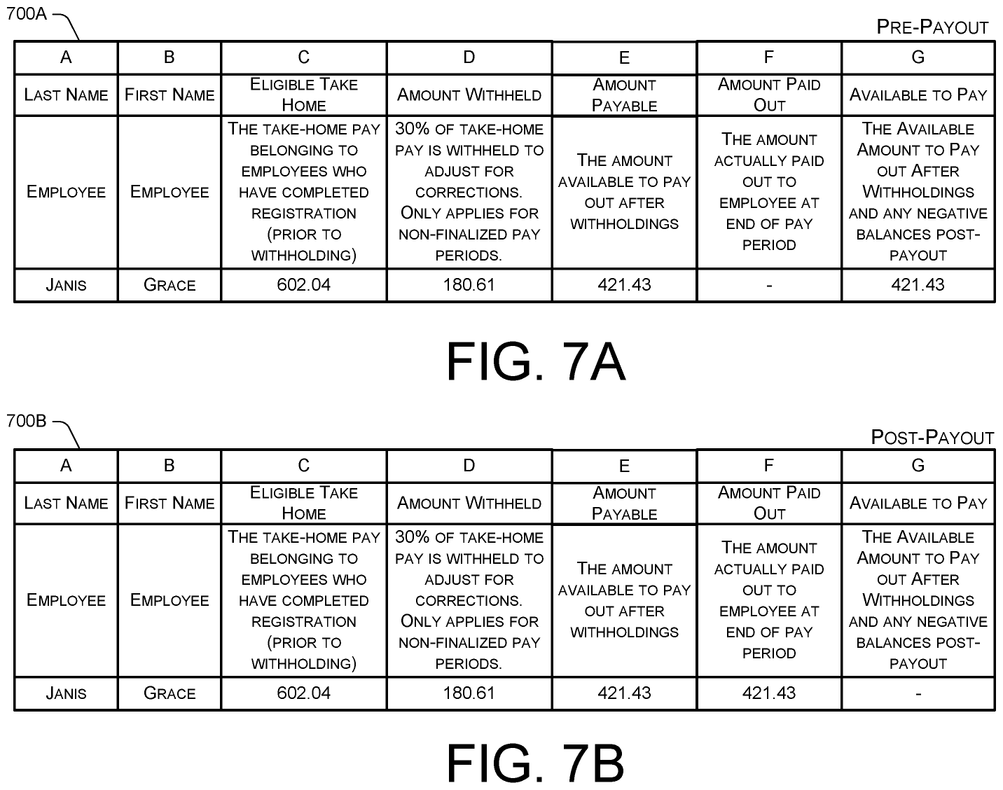

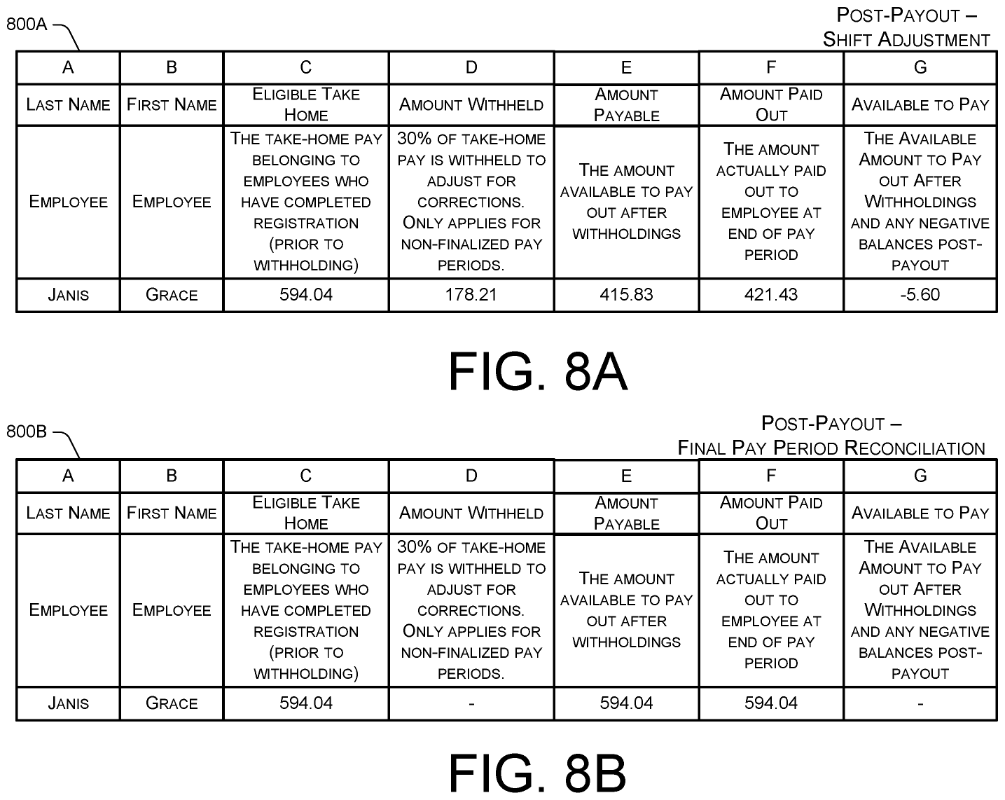

FIGS. 7A-8B illustrate an example of a reconciliation process performed, e.g., by the reconciliation module 222 according to at least one embodiment. The reconciliation module 222 allows the employer to see the amount of tips that each employee is eligible to take home, the percentage amount that is withheld pending reconciliation, the amount that is payable, the amount that is available for payout, and the actual amount that was paid out to an employee. Withholding in this way allows for the ability to hold a percentage of funds until the end of the pay period, in turn allowing for final reconciliation for any changes to an employee's earnings. For example, changes to an employee's earnings can be from a refund, shift change, clock adjustment, etc. At the end of a pay period, the subscriber can finalize its data, and the platform may reconcile the data, taking any negative adjustment amounts and applying them to the withheld amount. This provides the final amount the employee is able to receive.

FIG. 7A illustrates the “Pre-Payout” status for Employee Grace Janis in table 700A. Table 700A, for example, may be displayed via a user display at the POS 110. Although there is no limitation on the information or format of the displayed information, Table 700A has seven columns A-G for, respectively, Employee Last Name, Employee First Name, the employee's eligible take-home pay, the amount withheld to adjust for corrections, the amount payable after corrections, the amount paid out, and the amount available to pay out.

Column A may contain the entry for the employee's last name (here, Janis). Column B may contain the entry for the employee's first name (Grace). This is among the employee information that may be entered by the user 112 as described elsewhere herein.

Column C may contain a calculation of take-home pay at the end of a pay period, prior to any withholdings to adjust for corrections. “Withholding” as used here does not refer to tax, health insurance, retirement, or other withholdings commonly made from a worker's gross pay. The reconciliation process calls for the withholding of a preset percentage of “eligible take-home pay”. The concept extends to tip-only pay (i.e., take-home pay from tips only), take-home pay from base pay+tips, and take-home pay from base pay only. Therefore, “eligible take-home pay” may be base pay, tip share calculated from accumulated gross tips to be distributed to all employees who are eligible to share in the tips according to the tip distribution policy, or a combination of the two. In this example, Grace Janis's eligible take-home is $602.04.

Column D may contain the preset percentage of eligible take-home to be deducted, e.g., during each pay period, pending adjustments for corrections. As indicated in FIG. 7A, in this example withholding is not made for finalized pay periods, but only applies to non-finalized pay periods. This is so that a finalized pay period is not reopened to potentially claw back withholdings that have already been distributed. In FIG. 7A, the amount withheld is 30% of the eligible take-home, or $180.61.

Column E may contain the amount payable to Grace Janis in this pre-payout stage, calculated by subtracting the amount withheld from the eligible take-home, or $421.43 ($602.04−$180.61=$421.43).

Column F is to show the actual amount paid out at the end of the pay period after corrections, but in this pre-payout stage does not show an actual amount paid out. Column G shows the amount available to pay Grace Janis after any corrections have been made, which at this stage is the same as the amount payable shown in Column E, no adjustments having been made for this pay period.

FIG. 7B illustrates a similar table, Table 700B, which shows updated information post-payout. Post-payout, data that could be expected to change is the amount paid out in Column F and/or the amount available to pay in Column G. In this example, no adjustments having been made, the amount paid out is $421.43 (Column F) and there is no amount left (available) to pay in Column G.

FIG. 8A illustrates, in Table 800A, changes due to the calculation of adjustments to the eligible take-home shown in Column C, which results in corresponding changes to the amount withheld, amount payable, amount paid out, and amount available to pay in Columns D-G, respectively. In this example, Grace Janis's eligible take-home pay has been reduced by $8.00 on account of her having clocked in for one hour more than the length of the shift in which she was eligible to share tips (e.g., she was clocked in for nine hours but worked an eight-hour shift, or she worked nine hours but only eight hours were eligible for tip sharing) and being paid for the extra hour. There, in a shift adjustment, one hour was deducted, leaving her with $594.04 in eligible take-home pay (Column C), a change to the amount withheld in Column D (now $178.21, or 30% of $594.04), and a new amount payable in Column E ($415.83, or $594.04−$178.21). As she had already been paid $421.43 (Table 700B), Column G shows a negative balance of −$5.60. This is the amount of adjustment that will complete reconciliation.

FIG. 8B shows the post-payout, final pay period reconciliation. Column C continues to show $594.04 as the eligible take-home pay. Now, however, the negative balance of −$5.60 has been applied, e.g., to the total amount paid out, rendering it $172.61 ($178.21−$5.60=$172.61), so there is no value in Column D for amount withheld, i.e., the correction has been made so the remainder of the amount withheld is released. Because no more adjustments are to be made, the amount payable to Grace Janis (Column E) is $594.04 and, upon distribution, she will receive $594.04 as the amount paid out (Column F). Column G is empty because the negative balance has been zeroed.

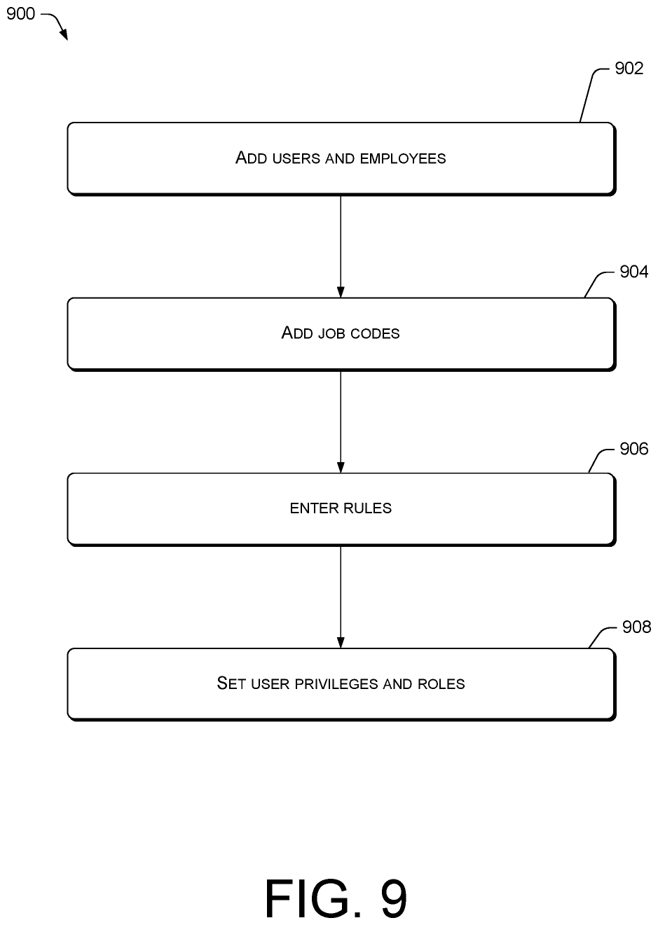

FIGS. 9-12 are example methodological implementations of a distribution policy in determining how to apportion a gratuity at the end of a gratuity distribution period, in accordance with at least one embodiment. In the following discussion, continuing reference is made to the elements and reference numerals shown in and described with respect to the network environment 200 illustrated in FIG. 2. Further, certain operations may be ascribed to particular system elements shown in previous figures. However, alternative implementations may execute certain operations in conjunction with or wholly within a different element or component of the system(s). For example, some or all of the operations executed on the accounting management server may be performed on the POS. Furthermore, to the extent that certain operations are described in a particular order, it is noted that some operations may be implemented in a different order to produce similar results.

FIG. 9 is a flow diagram of an example methodological implementation 900 of setting up a distribution policy to be carried out, for example, by a user 112 entering data and rules in the accounting management server 202 of FIG. 2.

At block 902, the user 112 may add users and employees into fields of a wizard displayed on a user interface of the POS. The users may include the users 112 and the employees may include the employees 130.

At block 904, the user 112 may enter job codes. The job codes may be associated with employee job roles such as server, valet, busser, bartender, cook, and more. Some job codes pertain to tip earners while others pertain to those, like cooks or managers, who do not generally earn tips directly. The job codes can also include ghost job codes or “none”, associated with those like managers who ordinarily do not participate in tip-earning activity but may pitch in at times. “None” codes can also be associated with employees who fill online orders and/or make deliveries. “None” codes should be resolved to actual job codes before tip distribution.

At block 906, the user 112 may enter rules. The rules determine tip apportionment and distribution as described herein. Apportionment is not always simple percentage assignment, although typically apportionment is based on percentages assigned to job roles. In some embodiments, apportionment may be based on other factors as well, such as shift, time of day, day of week, employee experience level, whether tips are shared or pooled, and more. The rules may also include weights set for modifying strict percentages or using ratios rather than percentages per se. The rules may be edited as necessary.

At block 908, the user 112 may enter user privileges and roles. For example, an administrator may have the most access privileges, including the authority to enter and edit rules and job codes. A manager may have authority to enter job codes and adjust employee shifts. The manager may also have the authority to override percentages or other rules in certain instances for certain times. An employee may have the authority only to clock in and view gratuity reconciliations.

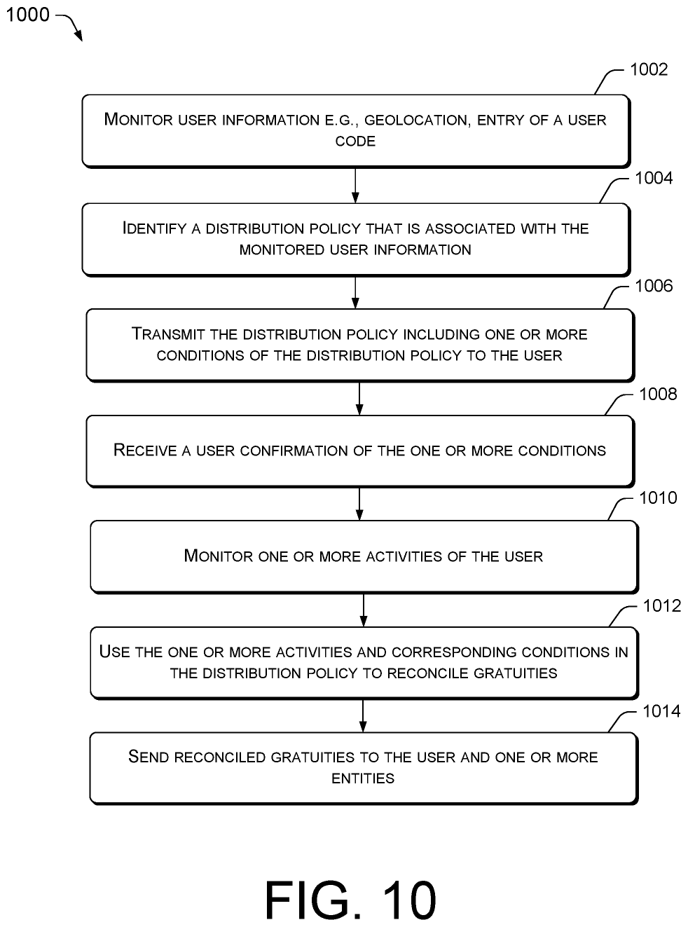

FIG. 10 is a flow diagram of an example methodological implementation 1000 by the accounting management server 202 of a distribution policy in determining how to apportion a gratuity at the end of a gratuity distribution period, in accordance with at least one embodiment.

At block 1002, the accounting management server 202 may monitor employee information including a geolocation, an entry of an employee code, and/or other information that relate to employment of the user. For example, the employee may enter a workplace, and the geolocation (determined by detecting the employee's user device via GPS, for example) of the employee triggers a start of a time of the shift. In another example, entry of the employee code in the POS, detection of a radio frequency identification (RFID) signal that can be detected upon entry of the employee in the main gate of the establishment, may provide the trigger.

At block 1004, the accounting management server 202 may identify a distribution policy that is associated with the monitored user information. In one example, the distribution policy, as it relates to the employee, may define time of work, percentage sharing, conditions for the reconciliation of gratuities, gratuity distribution period such as the time of sale or shift, and other information such as the entities that can be authorized to access the information of the employee or receive gratuities from or on behalf of the employee. In another example, a tip management platform may enable one with the necessary permissions to configure the reconciliation of the gratuities to the employee, assign different job codes, assign multiple schedules that can be the basis for employee's percentage sharing, and other information that relate to the apportionment and reconciliation of the gratuities.

At block 1006, the accounting management server 202 may transmit to the employee for confirmation, or simply for information, one or more items related to the distribution policy. For example, the items may include the start of the time of work for the day, name of the employer in case the employee is employed in multiple establishments, gratuity distribution period to be applied such as the time of sale, and the like.

At block 1008, the accounting management server 202 may receive selection and/or confirmation by the user of the one or more conditions or rules of the associated distribution policy, in the event that block 806 calls for confirmation and is not just for information.

At block 1010, the accounting management server 202 may monitor activities related to the user's or employee's contribution to a tip-earning service. For example, the activities may include the opening of a transaction involving the employee, closing a transaction at the time of sale, clocking out for a break, clocking in after the break, and so on. In this example, each of these activities may correspond to conditions or events that relate to the calculation of the gratuities as described herein.

At block 1012, the accounting management server 202 may, based on the monitored activities and corresponding conditions, reconcile the pooled gratuities in accordance with the distribution policy.

At block 1014, the accounting management server 202 may send reconciled gratuities to the user and/or one or more entities in accordance with the distribution policy. The accounting management server 202 may also notify the employee of the gratuities and any action relative to them.

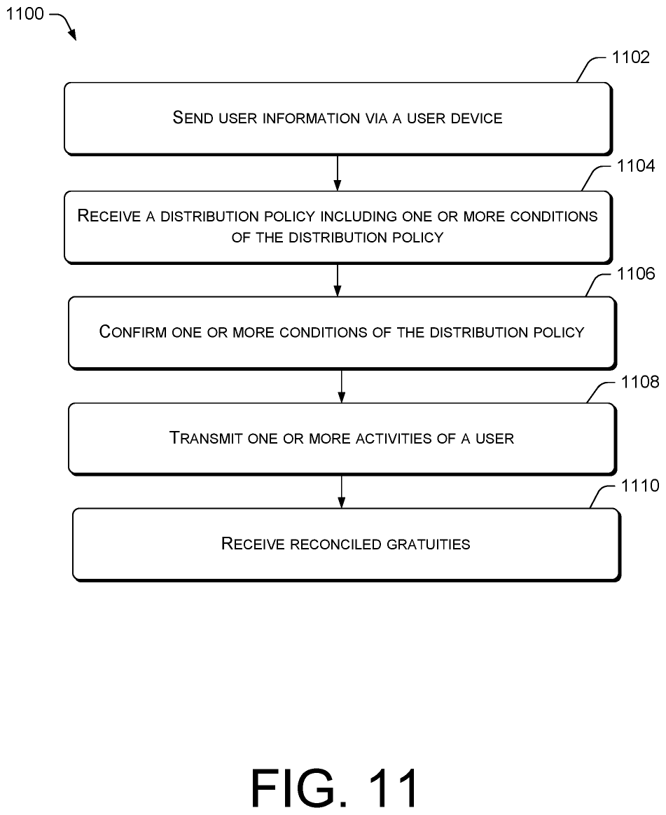

FIG. 11 is a flow diagram of an example methodological implementation 1100 for availing by the employee of features of the tip management application, such as the tip management application 262.

At block 1102, a user device 260 may send user information to the accounting management server. For example, the information may include the geolocation (determined by detecting the employee's user device via GPS, for example) of the employee, the employee code in the POS, a radio frequency identification (RFID) signal that can be detected upon entry of the employee in the main gate of the establishment, and the like.

At block 1104, the user device 260 may receive, for confirmation, or simply for information, one or more items related to the distribution policy. For example, the items may include the start of the time of work for the day, name of the employer in case the employee is employed in multiple establishments, gratuity distribution period to be applied such as the time of sale, and the like.

At block 1106, the user, via the user device 260, may confirm the one or more items of the distribution policy. In this example, the user device may send to the accounting management server, confirmation of the one or more items, feedback to correct errors, messages to request changes, and the like.

At block 1108, the user device 260 may transmit one or more activities of the user. For example, the user device may transmit the data that corresponds to completion of the transaction at the time of sale and, if the gratuity distribution period is at the time of sale, the user activity may trigger the calculation of the gratuity to be apportioned to the employee.

At block 1110, the user device 260 may receive reconciliation of gratuities at the time of sale. In one example, the user device may show to a user the apportioned gratuities in real-time, for the day, or expected gratuities at the end of business day, for individual distributions or a bulk distribution.

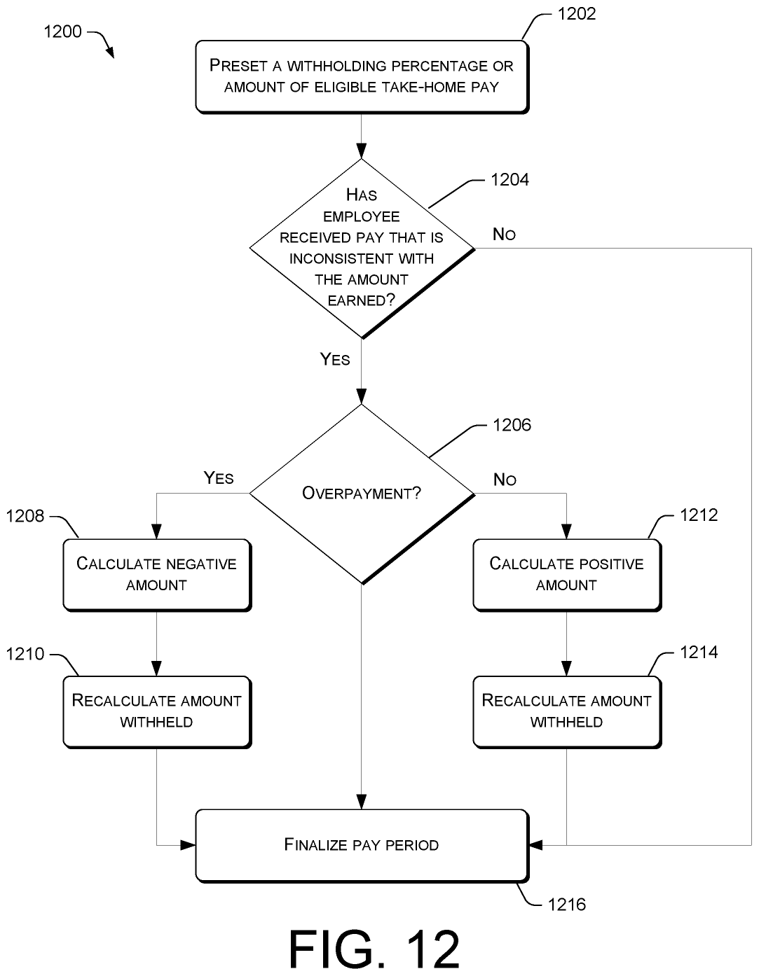

FIG. 12 is a flow diagram of an example methodological implementation 1200 that may be performed by the accounting management server 202 (specifically, the reconciliation module 222) to reconcile an employee's pay at the end of a pay period, in accordance with at least one embodiment. The implementation 1200 may be referenced to FIGS. 7A-8B, for example and without limitation.

At block 1202, the reconciliation module 222 may preset a percentage or amount of eligible take-home pay. Eligible take-home pay may include base pay, tip share calculated from accumulated gross tips to be distributed to all employees who are eligible to share in the tips according to the tip distribution policy, or a combination of the two. In the example of FIGS. 7A-8B, a percentage of eligible take-home pay is preset to 30%, but the amount is freely set by the administrator or other responsible person.

At decision block 1204, the reconciliation module 222 determines from stored records, or from new information, whether an employee has received pay that is inconsistent with the amount earned. For example, and without limitation, the employee, by virtue of clocking in for more hours than worked in a previous pay period and being paid accordingly, may be flagged for a reconciliation adjustment. If the answer is “Yes”, then the process continues to block 1206. If “No”, then the process continues to block 1216.

At block 1206, the reconciliation module 222 determines whether the employee received more money than she was entitled to receive. If the answer is “Yes”, then the process continues to block 1208. If the answer is “No”, then the process continues to block 1212.

At block 1208, because there was an overpayment determined, a negative amount is calculated to adjust an ensuing pay period payment to make up for the difference.

At block 1210, an amount withheld in the event of an overpayment is recalculated based on the adjustment.

At block 1216, the pay period is finalized in accordance with the negative adjustment.

At block 1212, following a determination at block 1206 that there was no overpayment (following a determination at block 1204 that there was a payment inconsistency), a positive amount is calculated to compensate for an underpayment.

At block 1214, the amount withheld is recalculated based on the adjustment.

At block 1216, the pay period is finalized in accordance with the positive adjustment.

### CONCLUSION

Although the subject matter has been described in language specific to features and methodological acts, it is to be understood that the subject matter defined in the appended claims is not necessarily limited to the specific features or acts described herein. Rather, the specific features and acts are disclosed as exemplary forms of implementing the claims.

What is claimed is:

1. One or more computer-readable media containing instructions that, if executed by one or more processors, cause the one or more processors to perform operations that comprise:
presetting a withholding percentage of eligible take-home pay for an employee;
determining whether the employee received pay that is inconsistent with an amount earned;
in response to determining that the employee received pay that is inconsistent with the amount earned:
calculating an adjustment amount;
adjusting the percentage of eligible take-home pay based on the adjustment amount; and
finalizing the pay period based on the recalculated percentage.

2. The one or more computer-readable media of claim 1, wherein the inconsistency is determined with respect to a previously finalized pay period.

3. The one or more computer-readable media of claim 1, wherein the operations further comprise:
determining a correct eligible take-home pay;
applying the withholding percentage to the correct eligible take-home pay;
reducing a result of applying the withholding percentage to the correct eligible take-home pay by a difference between the inconsistent pay and the correct eligible take-home pay;
adding the reduced result to the received pay; and
paying out the sum of the reduced result and the received pay.

4. The one or more computer-readable media of claim 1, wherein the eligible take-home pay comprises base pay and tip income.

5. The one or more computer-readable media of claim 1, wherein the eligible take-home pay comprises tip income only.

6. The one or more computer-readable media of claim 1, wherein the eligible take-home pay comprises base pay only.

7. The one or more computer-readable media of claim 1, wherein finalizing the pay period includes reconciling two pay periods to achieve a correct amount of take-home pay equal to the eligible take home pay for the subsequent pay period of the two pay periods.

8. A method of reconciling pay, comprising:
presetting a withholding percentage of eligible take-home pay for an employee;
determining whether the employee received pay that is inconsistent with an amount earned;
in response to determining that the employee received pay that is inconsistent with the amount earned:
calculating an adjustment amount;
adjusting the percentage of eligible take-home pay based on the adjustment amount; and
finalizing the pay period based on the recalculated percentage.

9. The method of claim 8, wherein the inconsistency is determined with respect to a previously finalized pay period.

10. The method of claim 8, wherein the operations further comprise:
determining a correct eligible take-home pay;
applying the withholding percentage to the correct eligible take-home pay;
reducing a result of applying the withholding percentage to the correct eligible take-home pay by a difference between the inconsistent pay and the correct eligible take-home pay;
adding the reduced result to the received pay; and
paying out the sum of the reduced result and the received pay.

11. The method of claim 8, wherein the eligible take-home pay comprises base pay and tip income.

12. The method of claim 8, wherein the eligible take-home pay comprises tip income only.

13. The method of claim 8, wherein the eligible take-home pay comprises base pay only.

14. The method of claim 8, wherein finalizing the pay period includes reconciling two pay periods to achieve a correct amount of take-home pay equal to the eligible take home pay for the subsequent pay period of the two pay periods.

15. A pay reconciliation system, comprising:
one or more processors; and
memory storing instructions that, if executed by the one or more processors, cause the one or more processors to perform operations that comprise:
presetting a withholding percentage of eligible take-home pay for an employee;
determining whether the employee received pay that is inconsistent with an amount earned;
in response to determining that the employee received pay that is inconsistent with the amount earned:
calculating an adjustment amount;
adjusting the percentage of eligible take-home pay based on the adjustment amount; and
finalizing the pay period based on the recalculated percentage.

16. The pay reconciliation system of claim 15, wherein the inconsistency is determined with respect to a previously finalized pay period.

17. The pay reconciliation system of claim 15, wherein the operations further comprise:
determining a correct eligible take-home pay;
applying the withholding percentage to the correct eligible take-home pay;
reducing a result of applying the withholding percentage to the correct eligible take-home pay by a difference between the inconsistent pay and the correct eligible take-home pay;
adding the reduced result to the received pay; and
paying out the sum of the reduced result and the received pay.

18. The pay reconciliation system of claim 15, wherein the eligible take-home pay comprises base pay and tip income.

19. The pay reconciliation system of claim 15, wherein the eligible take-home pay comprises tip income only.

20. The pay reconciliation system of claim 15, wherein the eligible take-home pay comprises base pay only.
